(19) United States
(12) Patent Application Publication
(10) Pub. No.: US 2016/0380309 A1
(43) Pub. Date: Dec. 29, 2016

(54) LONG-LIFE LITHIUM-ION BATTERIES

(71) Applicant: ARKEMA FRANCE, Colombes Cedex (FR)

(72) Inventors: Gregory SCHMIDT, Saint Andeol Le Chateau (FR); Bertrand COLLIER, Saint-Genis-Laval (FR); Philippe BONNET, Lyon (FR)

(73) Assignee: ARKEMA FRANCE, Colombes Cedex (FR)

(21) Appl. No.: 15/125,878

(22) PCT Filed: Mar. 9, 2015
(86) PCT No.: PCT/FR2015/050571

§ 371 Date: Sep. 13, 2016

(30) Foreign Application Priority Data
Mar. 14, 2014 (FR) 1452147

(51) Int. Cl. H01M 10/0568; H01M 4/485; H01M 4/505; H01M 4/525; H01M 10/0525; H01M 4/131

(52) U.S. Cl. CPC H01M 10/0568; H01M 10/0525; H01M 4/131; H01M 4/505; H01M 4/525; H01M 4/485; H01M 2300/0025; H01M 2004/028

(57) ABSTRACT

The invention relates to a battery comprising a cathode, an anode and electrolyte between said cathode and anode, in which: —the cathode comprises an oxide containing manganese as active substance; and —the electrolyte contains a lithium imidazolate of formula: (i) in which R, R¹ and R² independently of each other represent CN, F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ groups.

### FIELD OF THE INVENTION

The present invention relates to lithium-ion (Li-ion) batteries exhibiting an improved lifetime.

### TECHNICAL BACKGROUND

An elementary cell of an Li-ion storage battery or lithium battery comprises an anode (thus denoted by reference to the mode of discharge of the battery), which can, for example, be made of lithium metal or based on carbon, and a cathode (thus denoted by reference to the mode of discharge of the battery), which can, for example, comprise a lithium insertion compound of metal oxide type. An electrolyte which conducts lithium ions is inserted between the anode and the cathode.

In the event of use, thus during the discharging of the battery, the lithium released by oxidation at the (−) pole by the anode in the ionic form Li⁺ migrates through the conducting electrolyte and will be inserted by a reduction reaction in the crystal lattice of the active material of the cathode, (+) pole. The passage of each Li⁺ ion in the internal circuit of the battery is exactly compensated for by the passage of an electron in the external circuit, generating an electric current which can be used to supply various devices, in particular in the field of portable electronics, such as computers or telephones, or in the field of applications of greater power and energy density, such as electric vehicles.

During charging, the electrochemical reactions are reversed: the lithium ions are released by oxidation at the (+) pole consisting of the “cathode” (the cathode on discharging becomes the anode on recharging). They migrate through the conducting electrolyte in the reverse direction from that in which they circulated during the discharging, and will be deposited or will be inserted by reduction at the (−) pole consisting of the “anode” (the anode on discharging becomes the cathode on recharging), where they may form dendrites of lithium metal, which are possible causes of short circuits.

A cathode or an anode generally comprises at least one current collector on which is deposited a composite material which consists of: one or more “active” materials, called active because they exhibit an electrochemical activity with respect to lithium, one or more polymers which act as binder and which are generally functionalized or nonfunctionalized fluoropolymers, such as polyvinylidene fluoride, or aqueous-based polymers of carboxymethylcellulose type or styrene/butadiene latexes, plus one or more electron-conducting additives which are generally allotropic forms of carbon.

Possible active materials at the negative electrode (anode) are lithium metal, graphite, silicon/carbon composites, silicon, fluorographites of CFₓ type with x between 0 and 1, and titanates of LiTi₅O₁₂ type.

Possible active materials at the positive electrode are, for example, oxides of the LiMO₂ type, of the LiMPO₄ type, of the Li₂MPO₃F type and of the Li₂MSiO₄ type, where M represents Co, Ni, Mn, Fe and the combinations of these, of the LiMn₂O₄ type or of the S₈ type.

Manganese oxide with a structure of the spinel type is a cathode material which is particularly advantageous as a result of its relatively low cost, of the low pollution generated in comparison with cobalt-based cathodes, for example, of the high lithium insertion potential and of its use in high-power batteries.

However, this material exhibits the major disadvantage of exhibiting a poor cycling performance. This is because, in the paper by Tarascon et al. (J. Electrochem. Soc., 1991, 10, 2859-2864), it has been shown that this material operates at a potential of 4.1 V with a specific energy close to the theoretical value but, in particular, that a loss of 10% of this energy is observed after 50 cycles.

This loss of capacity appears to be essentially due to an attack of the HF (see the paper by K. Amine et al., J. Power Sources, 2004, 129, 14) generated by the presence of water (at a concentration of the order of one ppm) in conventional electrolytes, which are based on the lithium hexafluorophosphate (LiPF₆) salt. The HF has a tendency to dissolve, in the electrolyte, the manganese present in the cathode. This manganese is subsequently reduced at the anode in metallic form, which brings about an increase in the internal resistance causing a deterioration in the performance of the battery and increasing the dangerousness of this battery.

Several avenues have been envisaged in order to avoid this problem.

For example, provision has been made to stabilize the spinel structure by the addition of other metals to the crystal structure, such as cobalt, nickel or aluminum (paper by Tarascon et al., J. Power Sources, 1999, 39, 81-82). However, these additions result either in an additional cost, on the one hand, or in a decrease in potential or an increase in the pollution generated, on the other hand.

Another solution envisaged is the addition of an additive to the electrolyte capable of trapping the small amounts of water present but, here again, this solution results in an additional cost for the electrolyte and does not improve the performance in terms of lifetime.

Furthermore, the use of a lithium imidazolate or of a mixture of lithium imidazolate and of another lithium salt as electrolyte is known in particular from the documents WO 2010/023413 and WO 2013/083894.

There thus exists a real need to provide lithium-ion batteries having an improved lifetime.

There exists in particular a need to provide lithium-ion batteries which exhibit both a satisfactory lifetime and a high potential and can be manufactured without excessive cost and without generating excessive pollution.

### SUMMARY OF THE INVENTION

The invention relates first to a battery comprising a cathode, an anode and an electrolyte interposed between the cathode and the anode, in which:
the cathode comprises an oxide containing manganese as active material; and
the electrolyte contains a lithium imidazolate of formula:

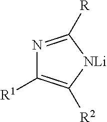

in which R, R¹ and R² independently represent CN, F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ groups.

According to an embodiment, at least one among R, R¹ and R² represents a CN group.

According to one embodiment, R¹ and R² each represent a CN group.

According to one embodiment, R represents a CF₃, F or C₂F₅ group and more particularly preferably represents a CF₃ group.

According to one embodiment, the electrolyte consists essentially of one or more lithium imidazolates in a solvent.

According to one embodiment, the cathode contains:
a lithium manganese oxide of formula LiₓMn₂O₄ where X represents a number ranging from 0.95 to 1.05; and/or
an oxide of formula LiMO₂ where M is a combination of Mn with one or more other metals, such as Co, Ni, Al and Fe;
as active material.

According to one embodiment, the cathode comprises an oxide containing manganese which exhibits a structure of spinel type.

The present invention makes it possible to overcome the disadvantages of the state of the art. It more particularly provides lithium-ion batteries having an improved lifetime; these lithium-ion batteries exhibit both a satisfactory lifetime and a high potential and can be manufactured without excessive cost and without generating excessive pollution.

The invention is a consequence of the discovery by the present inventors that the presence of a lithium imidazolate salt in the electrolyte makes it possible to reduce the dissolution of the manganese and thus to improve the performance of Li-ion batteries having a cathode of oxide type containing manganese.

This effect is particularly marked with crystal structures of spinel type, which have a tendency to be less stable than crystal structures of lamellar type (while exhibiting the advantage of operating at a higher voltage).

Finally, the present invention shows that the imidazolate salt makes it possible to avoid the loss of the capacity which, under specific conditions, are due to the dissolution of the manganese.

### BRIEF DESCRIPTION OF THE FIGURES

FIG. 1 is a diagram which illustrates the capacity of batteries with an electrolyte based on LiPF₆ or based on LiTDI, in mA.h/g (axis of the ordinates), as initial charge capacity (1) or after aging (2). Reference is made, in this regard, to example 1.

FIG. 2 is a diagram which illustrates the discharge capacity, in mA.h (axis of the ordinates), as a function of the number of cycles (axis of the abscissi), for batteries with an electrolyte based on LiPF₆ or based on LiTDI. Reference is made, in this regard, to example 2.

FIG. 3 is a diagram which illustrates the discharge capacity, in mA.h (axis of the ordinates), as a function of the number of cycles (axis of the abscissi), for batteries with an electrolyte based on LiPF₆ or based on LiTDI. Reference is made, in this regard, to example 3.

FIG. 4 is a diagram which illustrates the discharge capacity, in mA.h (axis of the ordinates), as a function of the number of cycles (axis of the abscissi), for batteries with an electrolyte based on LiPF₆ (curve 1) or based on LiTDI (curve 2) or based on a mixture of LiTDI and LiPF₆ in a 20:80 molar ratio (curve 3) or based on a mixture of LiTDI and LiPF₆ in an 80:20 molar ratio (curve 4). Reference is made, in this regard, to example 4.

### DESCRIPTION OF EMBODIMENTS OF THE INVENTION

The invention is now described in more detail and without implied limitation in the description which follows.

A battery according to the invention comprises at least one cathode, one anode and an electrolyte interposed between the cathode and the anode.

The terms of cathode and of anode are given with reference to the mode of discharge of the battery.

According to an embodiment, the battery exhibits several cells, which each comprise a cathode, an anode and an electrolyte interposed between the cathode and the anode. In this case, preferably, all of the cells are as described above in the summary of the invention. Furthermore, the invention also relates to an individual cell comprising a cathode, an anode and an electrolyte, the cathode and the electrolyte being as described above in the summary of the invention.

The cathode comprises an active material. The term “active material” is understood to mean a material into which the lithium ions resulting from the electrolyte are capable of being inserted and from which the lithium ions are capable of being released into the electrolyte.

According to the invention, the active material of the cathode comprises an oxide containing manganese.

The following are in particular preferred:
a lithium manganese oxide of formula LiₓMn₂O₄ where X represents a number ranging from 0.95 to 1.05; and
an oxide of formula LiMO₂ where M is a combination of Mn with one or more other metals, such as Co, Ni, Al and Fe.

A mixture of the two types of oxide above is also possible, preferably with a ratio by weight of the first type of oxide to the second type of oxide ranging from 0.1 to 5, more particularly from 0.2 to 4.

According to one embodiment, the active material of the cathode consists essentially of, preferably consists of, an oxide containing manganese, which is preferably of the first type or of the second type mentioned above (or which is a mixture of the two types as described above).

The active material of the cathode preferably has a structure of spinel type, that is to say an octahedral crystal structure. Alternatively, the active material can exhibit a structure of lamellar type. A characterization by X-ray diffraction, for example, makes it possible to distinguish these structures.

An active material of LiMn₂O₄ type is particularly preferred.

An active material of LiMn_{1/3}Ni_{1/3}Co_{1/3}O₂ type is also particularly preferred.

In addition to the active material, the cathode can advantageously comprise:
an electron-conducting additive; and/or
a polymer binder.

The cathode can be in the form of a composite material comprising the active material, the polymer binder and the electron-conducting additive.

The electron-conducting additive can, for example, be present at a content ranging from 1 to 2.5% by weight, preferably from 1.5 to 2.2% by weight, with respect to the total weight of the cathode. The ratio by weight of the binder with respect to the electrode-conducting additive can, for example, be from 0.5 to 5. The ratio by weight of the active material with respect to the conducting additive can, for example, be from 30 to 75.

The electron-conducting additive can, for example, be an allotropic form of carbon. Mention may in particular be made, as electron conductor, of carbon black, SP carbon, carbon nanotubes and carbon fibers.

The polymer binder can, for example, be a functionalized or nonfunctionalized fluoropolymer, such as polyvinylidene fluoride, or an aqueous-based polymer, for example carboxymethylcellulose, or a styrene/butadiene latex.

The cathode can comprise a metal current collector on which the composite material is deposited.

The manufacture of the cathode can be carried out as follows. All the abovementioned compounds are dissolved in an organic or aqueous solvent in order to form an ink. The ink is homogenized, for example using an Ultra-Turrax. This ink is subsequently rolled over the current collector and the solvent is removed by drying.

The anode can, for example, comprise lithium metal, graphite, carbon, carbon fibers, an Li₄Ti₅O₁₂ alloy or a combination of these. The composition and the method of preparation are similar to those of the cathode, with the exception of the active material described above.

The electrolyte comprises one or more lithium salts in a solvent.

The lithium salts include at least one lithium imidazolate of formula:

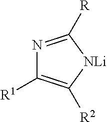

in which R, R¹ and R² independently represent CN, F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ groups.

Preferred lithium imidazolates are those for which R¹ and R² represent a cyano CN group and very particularly those for which R represents CF₃ or F or C₂F₅.

Lithium 1-trifluoromethyl-4,5-dicyanoimidazolate (LiTDI) and lithium 1-pentafluoroethyl-4,5-dicyanoimidazolate (LiPDI) are particularly preferred.

Use may also be made of a mixture of lithium imidazolates as described above.

In addition, other lithium salts can also be present, for example chosen from LiPF₆, LiBF₄, CF₃CO₂Li, a lithium alkylborate, LiTFSI (lithium bis(trifluoromethanesulfonyl)imide) or LiFSI (lithium bis(fluorosulfonyl)imide).

According to a specific embodiment, the lithium imidazolate or imidazolates represent at least 50%, preferably at least 75%, or at least 90%, or at least 95% or at least 99%, in molar proportion, of the total lithium salts present in the electrolyte.

According to a specific embodiment, the electrolyte consists essentially of one or more lithium imidazolates and a solvent or consists of one or more lithium imidazolates and a solvent—with the exclusion in particular of any other lithium salt.

For example, the electrolyte can consist essentially of LiTDI in a solvent or can consist of LiTDI in a solvent.

For example again, the electrolyte can consist essentially of LiPDI in a solvent or can consist of LiPDI in a solvent.

The solvent of the electrolyte consists of one or more compounds which can, for example, be chosen from the following list: carbonates, such as ethylene carbonate, dimethyl carbonate, ethyl methyl carbonate, diethyl carbonate or propylene carbonate; glymes, such as ethylene glycol dimethyl ether, diethylene glycol dimethyl ether, dipropylene glycol dimethyl ether, diethylene glycol diethyl ether, triethylene glycol dimethyl ether, diethylene glycol dibutyl ether, tetraethylene glycol dimethyl ether and diethylene glycol t-butyl methyl ether; or nitrile solvents, such as methoxypropionitrile, propionitrile, butyronitrile or valeronitrile.

Use may be made, for example, as solvent, of a mixture of ethylene carbonate and dimethyl carbonate.

The molar concentration of lithium salt in the electrolyte can range, for example, from 0.01 to 5 mol/l, preferably from 0.1 to 2 mol/l, more particularly from 0.5 to 1.5 mol/l.

The molar concentration of lithium imidazolate in the electrolyte can range, for example, from 0.01 to 5 mol/l, preferably from 0.1 to 2 mol/l, more particularly from 0.3 to 1.5 mol/l.

The applicant company has observed that the conditions which are particularly advantageous for preventing the loss of capacity subsequent to the dissolution of manganese are:
a voltage of between 4 and 4.4, preferably between 4.15 and 4.25, advantageously 4.2,
a temperature of between 45° C. and 65° C., preferably between 50° C. and 60° C., advantageously 55±2° C.

### EXAMPLES

The following examples illustrate the invention without limiting it.

### Example 1

### Improvement in the Calendar Lifetime

Two batteries of CR2032 type are manufactured: the cathode consists of a manganese oxide of spinel type LiMn₂O₄, of conducting additive (SP carbon) and of a binder of PVDF type (Kynar®, sold by Arkema) and an anode made of lithium metal.

The mean initial capacity is determined after 10 cycles at a rate of C/5, that is to say charging in 5 hours and discharging in 5 hours.

A voltage is subsequently applied to the batteries at a potential of 4.2 V at 55° C. for 15 days. The capacity after aging is determined by the same protocol as above.

One of the batteries is produced with an electrolyte composed of LiPF₆ at 1 mol/l in a 1/1 mixture by weight of ethylene carbonate and dimethyl carbonate. The other battery is composed of an electrolyte consisting of LiTDI at a concentration of 0.4 mol/l in a 1/1 mixture by weight of ethylene carbonate and dimethyl carbonate.

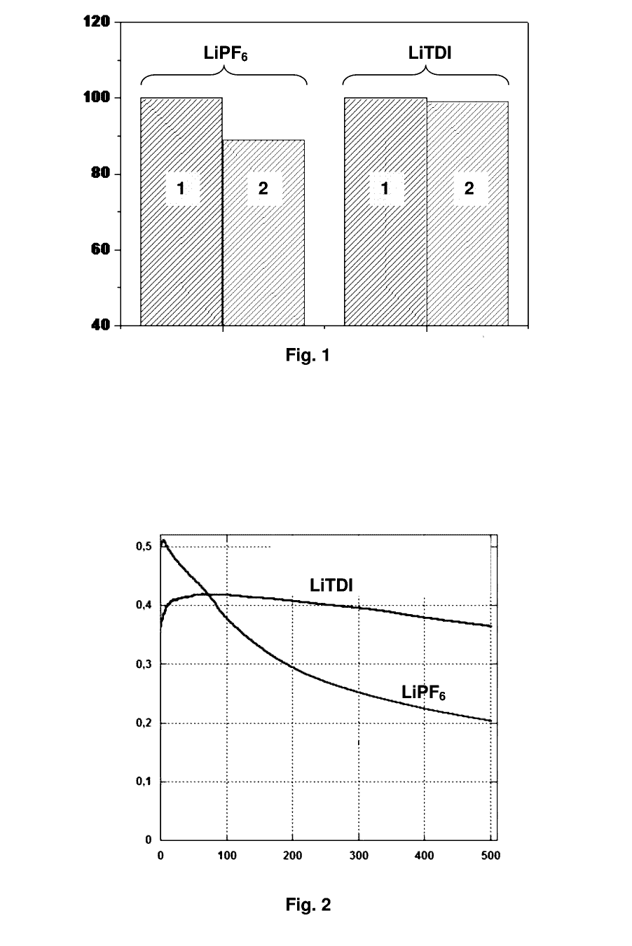

FIG. 1 represents the initial capacities and the capacities after aging. The battery with the electrolyte based on LiPF₆ exhibits a loss of approximately 12%, whereas the battery with the electrolyte based on LiTDI exhibits a loss of 1% only.

### Example 2

Two batteries of CR2032 type are manufactured: the cathode consists of a manganese oxide of spinel type LiMn₂O₄, of conducting additive (SP carbon) and of a binder of PVDF type (Kynar®, sold by Arkema), everything being deposited on aluminum, and the anode consists of graphite, of conducting additive (SP carbon) and of a binder of PVDF type (Kynar®, sold by ARKEMA), everything being deposited on copper.

One of the batteries is produced with an electrolyte composed of LiPF₆ at 1 mol/l in a 1/1 mixture by weight of ethylene carbonate and dimethyl carbonate.

The other battery is produced with an electrolyte composed of LiTDI at a concentration of 0.4 mol/l in a 1/1 mixture by weight of ethylene carbonate and dimethyl carbonate.

The batteries are cycled at a rate of C, that is to say charging in 1 hour and discharging in 1 hour, between 2.7 and 4.2 V at an unvarying temperature of 25° C.

FIG. 2 shows the change in the capacity of these two batteries as a function of the number of cycles.

The battery with an electrolyte based on LiPF₆ exhibits a better initial capacity as a result of its better ionic conductivity. However, the decrease in the capacity over the cycles takes place more rapidly with LiPF₆ than with LiTDI.

### Example 3

### Improvement in the Lifetime in Cycling

Two batteries of CR2032 type are manufactured: the cathode consists of a manganese, nickel and cobalt oxide of formula LiMn_{1/3}Ni_{1/3}Co_{1/3}O₂, of conducting additive (SP carbon) and of a binder of PVDF type (Kynar®, sold by Arkema), everything being deposited on aluminum, and the anode consists of graphite, of conducting additive (SP carbon) and of a binder of PVDF type (Kynar®, sold by Arkema), everything being deposited on copper. One of the batteries is produced with an electrolyte composed of LiPF₆ at 0.75 mol/l in a 1/1 mixture by weight of ethylene carbonate and dimethyl carbonate.

The other battery is composed of an electrolyte consisting of LiTDI at a concentration of 0.75 mol/l in a 1/1 mixture by weight of ethylene carbonate and dimethyl carbonate.

The batteries undergo, in a first step, “formation” cycles in order to create the SEI film on the anode. These cycles, of which there are 10, are carried out at a rate of C/10, that is to say charging in 10 hours and discharging in 10 hours, between 2.7 and 4.2 V at an unvarying temperature of 25° C.

The batteries are subsequently cycled at a rate of C/3, that is to say charging in 3 hours and discharging in 3 hours, between 2.7 and 4.2 V at an unvarying temperature of 25° C.

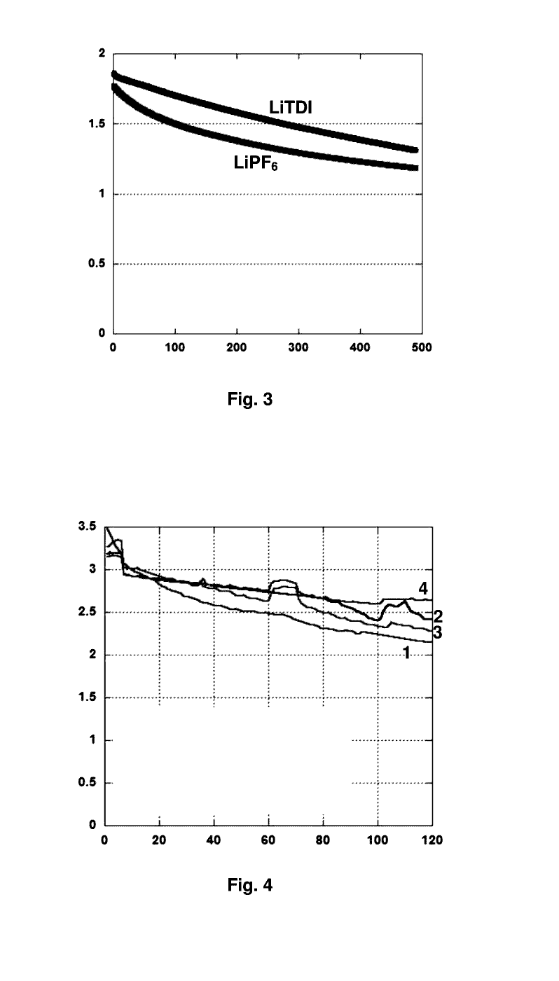

FIG. 3 shows the change in the capacity of these two batteries as a function of the number of cycles after the formation cycles. The battery with an electrolyte based on LiPF₆ exhibits a faster decrease in the capacity over the cycles than the battery with an electrolyte based on LiTDI.

### Example 4

### Improvement in the Lifetime in Cycling and Mixture of Lithium Salts

Four batteries of CR2032 type are manufactured: the cathode consists of a manganese, nickel and cobalt oxide of formula LiMn_{1/3}Ni_{1/3}Co_{1/3}O₂, of conducting additive (SP carbon) and of a binder of PVDF type (Kynar®, sold by Arkema), everything being deposited on aluminum, and the anode consists of graphite, of conducting additive (SP carbon) and of a binder of PVDF type (Kynar®, sold by Arkema), everything being deposited on copper.

The batteries are produced with an electrolyte composed either of 1 mol/l LiPF₆ or of 0.75 mol/l LiTDI or of a mixture of 0.2 mol/l LiPF₆ and 0.8 mol/l LiTDI or of a mixture of 0.8 mol/l LiPF₆ and 0.2 mol/l LiTDI, each time in a 1/1 mixture by weight of ethylene carbonate and dimethyl carbonate.

The batteries are subjected, in a first step, to “formation” cycles in order to create the SEI film on the anode. These cycles, of which there are 5, are carried out at a rate of C/10, that is to say charging in 10 hours and discharging in 10 hours, between 2.7 and 4.4 V at an unvarying temperature of 25° C.

The batteries are subsequently cycled at a rate of C/5, that is to say charging in 5 hours and discharging in 5 hours, between 2.7 and 4.4 V at an unvarying temperature of 25° C.

FIG. 4 shows the change in the capacity of these batteries as a function of the number of cycles after the formation cycles. The battery with an electrolyte based on LiPF₆ exhibits a faster decrease in the capacity over the cycles than the battery with an electrolyte additivated with or composed solely of LiTDI.

1. A battery comprising a cathode, an anode and an electrolyte interposed between the cathode and the anode, in which:
the cathode comprises an oxide containing manganese as active material; and
the electrolyte contains a lithium imidazolate of formula: 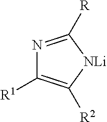
in which R, R¹ and R² independently represent CN, F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ groups.

2. The battery as claimed in claim 1, in which at least one among R, R¹ and R² represents a CN group.

3. The battery as claimed in claim 1, in which R¹ and R² each represent a CN group.

4. The battery as claimed in claim 1, in which R represents a CF₃, F or C₂F₅ group and more particularly preferably represents a CF₃ group.

5. The battery as claimed in claim 1, in which the electrolyte consists essentially of one or more lithium imidazolates in a solvent.

6. The battery as claimed in claim 1, in which the cathode contains:
a lithium manganese oxide of formula LiₓMn₂O₄ where X represents a number ranging from 0.95 to 1.05; and/or
an oxide of formula LiMO₂ where M is a combination of Mn with one or more other metals, such as Co, Ni, Al and Fe;
as active material.

7. The battery as claimed in claim 1, in which the cathode comprises an oxide containing manganese which exhibits a structure of spinel type.

8. A method of providing electrical power, comprising discharging a battery as claimed in claim 1 under the following conditions:
voltage of between 4 and 4.4 V,
temperature of between 45° C. and 65° C., whereby loss of capacity on cycling is reduced compared to a battery having a manganese oxide spinel cathode.
